(19) United States
(12) Patent Application Publication
(10) Pub. No.: US 2004/0123183 A1
(43) Pub. Date: Jun. 24, 2004

(54) Method and apparatus for recovering from a failure in a distributed event notification system

(76) Inventors: Ashutosh Tripathi, Fremont, CA (US); Nicholas A. Solter, Irvine, CA (US); Andrew L. Hisgen, New Providence, NJ (US); Martin Henry Rattner, Los Altos, CA (US)

Correspondence Address: PARK, VAUGHAN & FLEMING LLP, 508 SECOND STREET, SUITE 201, DAVIS, CA, 95616, US

(21) Appl. No.: 10/329,011

(22) Filed: Dec. 23, 2002

(51) Int. Cl. H04L 1/22

(52) U.S. Cl. 714/31

(57) ABSTRACT

One embodiment of the present invention provides a system that facilitates recovering from failure in a distributed event notification system. During operation, the system detects a failure of an event forwarder, which notifies subscribers of events generated by distributed components in the distributed computing system. In response to detecting the failure, the system restarts the event forwarder, typically on another node in the distributed computing system. Next, the system requests a snapshot of current state from the distributed components. In response to this request, the system subsequently receives events from the distributed components that specify current state of the distributed components, and then forwards the events to subscribers that are registered to be notified of the events.

### BACKGROUND

1. Field of the Invention

The present invention relates to the design of distributed computing systems. More specifically, the present invention relates to a method and an apparatus for recovering distributed state information to enable a distributed event notification system to recover from a failure.

2. Related Art

Distributed computing systems presently make it possible to develop distributed applications that can harness the computational power of multiple computing nodes in performing a computational task. This can greatly increase the speed with which the computational task can be performed. However, it is often hard to coordinate computational activities between application components running on different computing nodes within the distributed computing system.

In order to operate properly, distributed applications must somehow keep track of the state of application components to coordinate interactions between the application components. This can involve periodically exchanging “heartbeat” messages or other information between application components to keep track of which application components are functioning properly.

Some distributed operating systems presently keep track of this type of information for purposes of coordinating interactions between operating system components running on different computing nodes. However, these distributed operating systems only use this information in performing specific operating system functions. They do not make the information available to distributed applications or other clients.

Hence, in many situations, a distributed application has to keep track of this information on its own. Note that the additional work involved in keeping track of this information is largely wasted because the distributed operating system already keeps track of the information. Moreover, the task of keeping track of this information generates additional network traffic, which can impede communications between nodes in the distributed computing system.

Hence, what is needed is a method and an apparatus that enables a distributed application to be notified of events that occur on different computing nodes within a distributed computing system without requiring the distributed application to perform the event monitoring operations.

One challenge in performing event notification is to deal with failures that arise within the event delivery mechanism. One way to accomplish this is for the event delivery mechanism to guarantee delivery of events. However, this can be a challenge if the event delivery mechanism temporarily fails or fails over to another node in the distributed computing system.

One way to solve this problem is to checkpoint all events to non-volatile storage until all clients have received them, at which point they can be removed. Unfortunately, this solution requires (at least theoretically) an unbounded amount of storage. Furthermore, it is time-consuming to checkpoint every event to non-volatile storage in order to handle the rare failure case.

Hence, what is needed is method and an apparatus that guarantees delivery of event information without the above-described disadvantages of checkpointing all events to non-volatile storage.

### SUMMARY

One embodiment of the present invention provides a system that facilitates recovering from failure in a distributed event notification system. During operation, the system detects a failure of an event forwarder, which notifies subscribers of events generated by distributed components in the distributed computing system. In response to detecting the failure, the system restarts the event forwarder, typically on another node in the distributed computing system. Next, the system requests a snapshot of current state from the distributed components. In response to this request, the system subsequently receives events from the distributed components that specify current state of the distributed components, and then forwards the events to subscribers that are registered to be notified of the events.

In a variation on this embodiment, the events that specify the current state of the distributed components are received at the event forwarder through normal event notification channels.

In a variation on this embodiment, cluster membership events received from the distributed components include incarnation numbers for the underlying nodes of the distributed components, wherein the incarnation numbers allow subscribers to determine if a given underlying node has changed since the last time an event was received from the given underlying node.

In a variation on this embodiment, events generated by the distributed components are associated with changes of state in the distributed components.

In a further variation, events generated by the distributed components provide snapshots of current state information for the distributed components, instead of merely providing incremental state changes.

In a variation on this embodiment, the distributed components can include: nodes in the distributed computing system; applications running on nodes in the distributed computing system; and application components running on nodes in the distributed computing system.

In a variation on this embodiment, subscribers can include applications or application components running within the distributed computing system. They can also include applications or application components running outside of the distributed computing system.

In a variation on this embodiment, the events can include cluster membership events, such as a node joining the cluster or a node leaving the cluster. The events can also include events related to applications, such as a state change for an application (or an application component), or a state change for a group of related applications. Note that a state change for an application (or application component) can include: the application entering an on-line state; the application entering an off-line state; the application entering a degraded state, wherein the application is not functioning efficiently; and the application entering a faulted state, wherein the application is not functioning. The events can also include state changes related to monitoring applications or other system components, such as “monitoring started” and “monitoring stopped.”

### BRIEF DESCRIPTION OF THE FIGURES

FIG. 1 illustrates a distributed computing system in accordance with an embodiment of the present invention.

FIG. 2 illustrates a computing node in accordance with an embodiment of the present invention.

FIG. 3 illustrates components involved in the event forwarding process in accordance with an embodiment of the present invention.

FIG. 4 is a flow chart illustrating the registration process for event notification in accordance with an embodiment of the present invention.

FIG. 5 is a flow chart illustrating the process of forwarding an event in accordance with an embodiment of the present invention.

FIG. 6 presents a flow chart illustrating how the event forwarding mechanism recovers from a failure in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Distributed Computing System

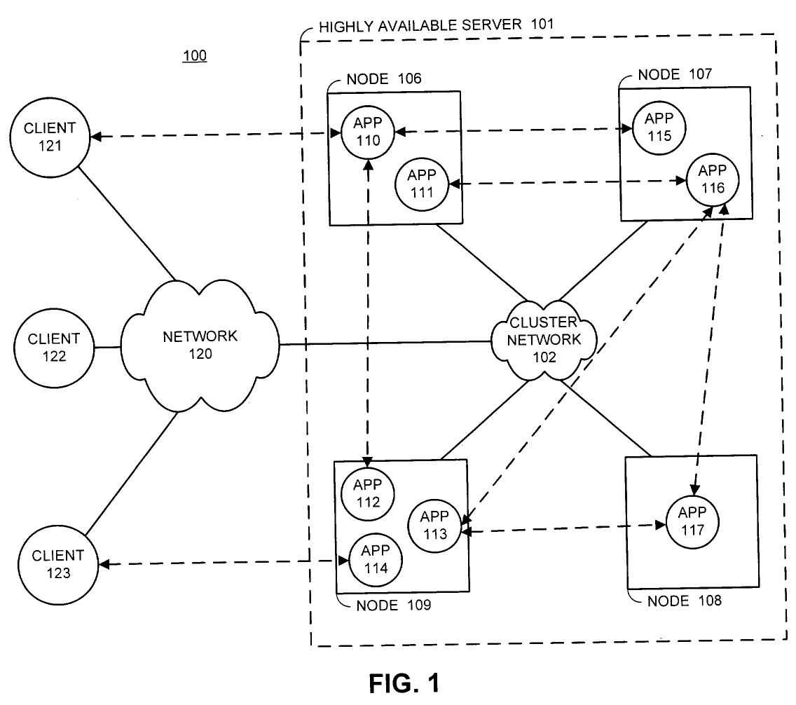

FIG. 1 illustrates a distributed computing system 100 in accordance with an embodiment of the present invention. As is illustrated in FIG. 1, distributed computing system 100 includes a number of clients 121-123 coupled to a highly available server 101 through a network 120. Network 120 can generally include any type of wire or wireless communication channel capable of coupling together computing nodes. This includes, but is not limited to, a local area network, a wide area network, or a combination of networks. In one embodiment of the present invention, network 120 includes the Internet. Clients 121-122 can generally include any node on a network including computational capability and including a mechanism for communicating across the network.

Highly available server 101 can generally include any collection of computational nodes including a mechanism for servicing requests from a client for computational and/or data storage resources. Moreover, highly available server 101 is configured so that it can continue to operate even if a node within highly available server 101 fails. This can be accomplished using a failover model, wherein if an instance of an application fails, a new instance is automatically started, possibly on a different node within the distributed computing system.

In the embodiment illustrated in FIG. 1, highly available server 101 includes a number of computing nodes 106-109 coupled together through a cluster network 102. Computing nodes 106-109 can generally include any type of computer system, including, but not limited to, a computer system based on a microprocessor, a mainframe computer, a digital signal processor, a portable computing device, a personal organizer, a device controller, and a computational engine within an appliance. Cluster network 102 can generally include any type of wire or wireless communication channel capable of coupling together computing nodes. This includes, but is not limited to, a local area network, a wide area network, or a combination of networks.

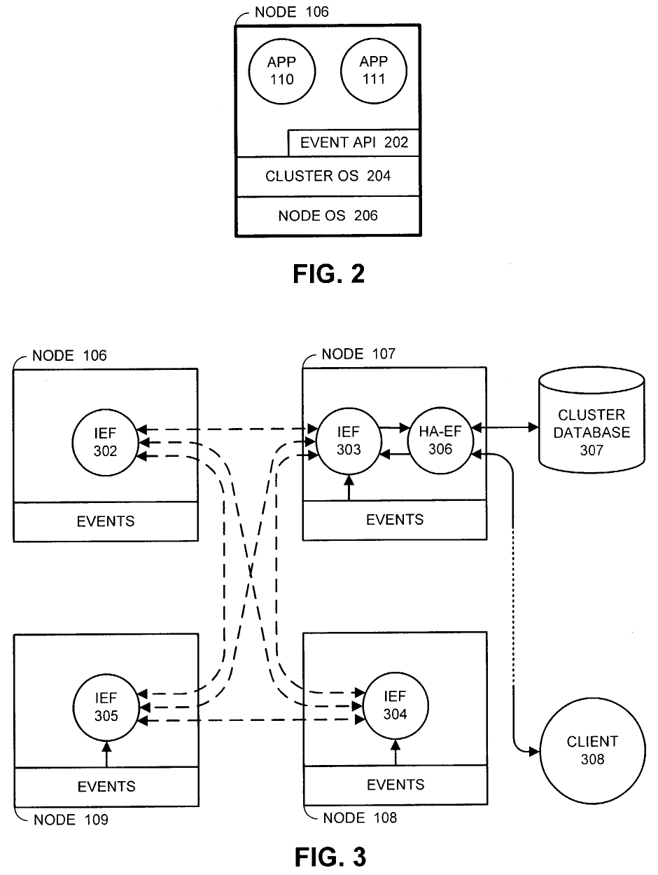

Computing nodes 106-109 host a number of application components 110-117, which communicate with each other to service requests from clients 121-123. Note that application components can include any type of application (or portion of an application) that can execute on computing nodes 106-109. During operation, resources within computing nodes 106-109 provide a distributed event notification mechanism that can be used by application components 110-117 to coordinate interactions between application components 110-117. This distributed event notification mechanism is described in more detail below with reference to FIGS. 2-5.

Note that although the present invention is described in the context of a highly available server 101, including multiple computing nodes 106-109, the present invention is not meant to be limited to such a system. In general, the present invention can be applied to any type of computing system with multiple computing nodes and is not meant to be limited to the specific highly available server 101 illustrated in FIG. 1.

Computing Node

FIG. 2 illustrates a computing node 106 in accordance with an embodiment of the present invention. Computing node 106 contains a node operating system (OS) 206, which can generally include any type of operating system for a computer system. Cluster operating system (OS) 204 runs on top of node OS 206, and coordinates interactions between computing nodes 106-109.

In one embodiment of the present invention, cluster OS 204 supports failover operations to provide high availability for applications running on computing nodes 106-109. In this embodiment, cluster OS 204 ensures that state information for an application is propagated to persistent storage. In this way, if the application fails, a new instance of the application can be automatically started by retrieving the state information from persistent storage. Note that the new instance of the application can be started on either the same computing node or a different computing node. Moreover, the failover operation generally takes place without significantly interrupting ongoing operations associated with the application.

Cluster OS provides an event application programming interface (API) that can be used by application components 110-11 to receive event notifications. More specifically, event API 202 enables application components: to register to be notified of events; to post events; and to and to receive notifications for events as is described below with reference to FIGS. 3-5.

Event Forwarding Components

FIG. 3 illustrates components involved in the event forwarding process in accordance with an embodiment of the present invention. As is illustrated in FIG. 3, computing nodes 106-109 in the highly available server 101 contain inter-node event forwarders (IEFs) 302-305, respectively. Each of these IEFs 302-305 receives events generated locally on computing nodes 106-109 and automatically communicates the events to all of the other IEFs as is illustrated by the dashed lines in FIG. 3.

Computing node 107 also contains a highly available event forwarder (HA-EF) 306, which is responsible for forwarding specific events to clients that desire to be notified of the specific events. HA-EF 306 does this by receiving an event from IEF 303 on computing node 107 and then looking up the event in a cluster database 307 to determine which clients desire to be notified of the event. HA-EF 306 then forwards the event to any clients, such as client 308, that desire to be notified of the event.

Note that client 308 can be located within computing nodes 106-109. For example, referring to FIG. 1, an application component 110 on computing node 106 can be notified of a change in state of an application component 115 on computing node 107. Client 308 can alternatively be located at a remote client. For example, referring to FIG. 1, an application on client 121 can be notified of state changes to a group of related application components 110, 115 and 112 running on computing nodes, 106, 107 and 109, respectively.

Note that HA-EF 306 is “highly available.” This means that if HA-EF 306 fails, a new instance of HA-EF 306 is automatically restarted, possibly on a different computing node. Note that HA-EF 306 can be restarted using client registration information stored within cluster database 307. In one embodiment of the present invention, when a new instance of HA-EF 306 is restarted, the new instance asks for a snapshot of the event information from all of the other nodes.

Also note that cluster database 307 is a fault-tolerant distributed database that is stored in non-volatile storage associated with computing nodes 106-109. In this way, the event registration information will not be lost if one of the computing nodes 106-109 fails.

Registration Process

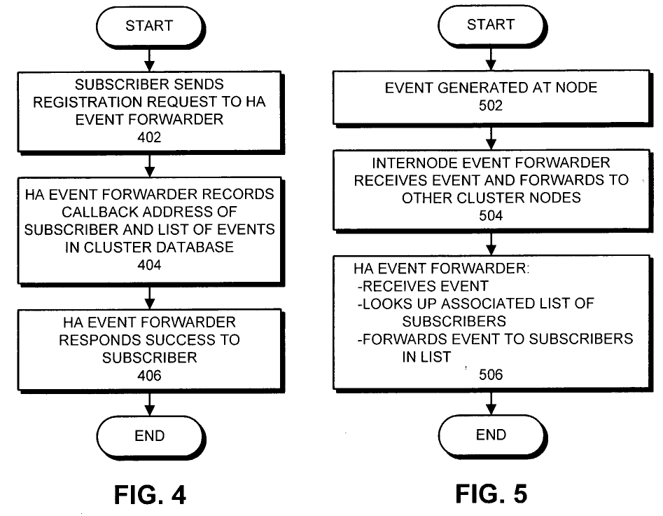

FIG. 4 is a flow chart illustrating the registration process for event notification in accordance with an embodiment of the present invention. The process starts when a subscriber, such as client 308 in FIG. 3, sends a registration request to HA-EF 306 (step 402). This can involve sending the registration request to an IP address associated with HA-EF 306. This registration request includes a callback address for client 308. For example, the callback address can include an Internet Protocol (IP) address and associated port number for client 308. The registration request also includes a list of events that client 308 is interested in being notified of.

Events in the list can include any type of events that can be detected within computing nodes 106-109. For example, the events can include cluster membership events, such as a node joining the cluster or a node leaving the cluster. The events can also involve applications. For example, the events can include: a state change for an application (or an application component) running within the distributed computing system, or a state change for a group of related applications running within the distributed computing system.

Note that a state change for an application (or application component) can include: the application entering an on-line state; the application entering an off-line state; the application entering a degraded state, wherein the application is not functioning efficiently; and the application entering a faulted state, wherein the application is not functioning. The events can also include state changes related to monitoring applications or other system components, such as “monitoring started” and “monitoring stopped.” Also note that the present invention is not limited to the types of events listed above. In general, any other type of event associated with a computing node, such as timer expiring or an interrupt occurring, can give rise to a notification.

Upon receiving the registration request, HA-EF 306 records the callback address of client 308 and the list of events in cluster database 307 (step 404). HA-EF 306 then responds “success” to client 308 and the registration process is complete (step 406). After registering for an event, client 308 can simply disconnect and does not need to maintain any connections to the cluster. When an event of interest subsequently arrives, HA-EF 306 initiates a connection to client 308 to deliver the event. Thus, client 308 does not need to do any maintenance, except for maintaining an open listening socket.

Event Forwarding Process

FIG. 5 is a flow chart illustrating the process of forwarding an event in accordance with an embodiment of the present invention. This process starts when an event is generated at one of computing nodes 106-109, for example computing node 106 (step 502). This event generation may involve an application component (or operating system component) posting the event through an event API on one of the computing nodes. In one embodiment of the present invention, events can be generated through the SOLARIS™ sysevent mechanism. (SOLARIS is a registered trademark of SUN Microsystems, Inc. of Santa Clara, Calif.)

Next, a local IEF 302 on computing node 106 receives the event and forwards the event to the other IEFs 303-305 located on the other computing nodes 107-109 (step 504). In one embodiment of the present invention, the event is added to the sysevent queue in the delivered nodes, which allows the event to be treated as if it was generated locally (except that it is not again forwarded to other nodes).

Next, HA-EF 306 receives the event and looks up an associated list of subscribers in cluster database 307. This lookup can involve any type of lookup structure that can efficiently lookup a set of interested subscribers for a specific event. HA-EF 306 then forwards the event to all of the subscribers in the list (step 506). This completes the event notification process.

Note that the event notification process facilitates the development of distributed applications because it allows application components running on different computing nodes to be informed of state changes in related application components without having to exchange heartbeat messages or other status information between the application components.

Also note that in many applications, it is important to guarantee a total ordering of events. Hence if events are missed, it is advantageous for subsequent events to indicate the total state of the system, so that subscribers are not left with an incorrect view of the event ordering.

Process of Recovering from an Event Forwarder Failure

Instead of checkpointing every event to non-volatile storage, the present invention relies on the event generating components to provide state information to facilitate recovery from a failure. Hence, HA-EF 306 does not maintain any copies of events. Instead, each event generating component in the system is instrumented with the ability to generate a “snapshot” of its state. Thus, when HA-EF 306 restarts after a failure, it simply requests “snapshots” from each event generating component. HA-EF 306 then forwards these snapshots to all subscribers of the events.

Instead of supporting two different types of events, one for normal incremental events and one for snapshots, one embodiment of the present invention requires all events to be in snapshot form. That is, none of the events provide only incremental changes of the component state.

Furthermore, in order to eliminate race conditions between normal events and snapshot events, one embodiment of the present invention requires snapshot events to use the same delivery channels as is used for normal events. This way, HA-EF 306 does not need to handle complicated ordering issues. It can simply forward events in the order it receives them from each source.

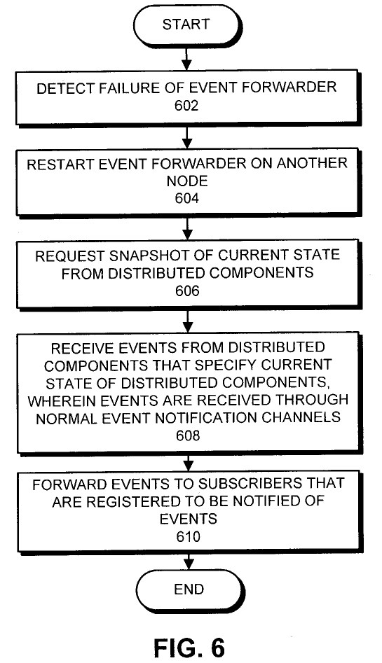

More specifically, FIG. 6 presents a flow chart of how HA-EF 306 recovers from a failure in accordance with an embodiment of the present invention. Upon detecting a failure of HA-EF 306 (step 602), the system restarts HA-EF 306, typically on another node in the distributed computing system (step 604). This restart process is well-known in the art and will not be discussed further herein.

Next, HA-EF 306 requests a snapshot of current state information from distributed components within the distributed computing system (step 606). In response to this request, the distributed components generate “snapshot events” containing snapshot information. HA-EF 306 subsequently receives these snapshot events from the distributed components (step 608). In order to prevent race conditions with normal events, the snapshot events are transferred to HA-EF 306 through normal event notification channels. This preserves ordering between the snapshot events and the normal state-change events.

In one embodiment of the present invention, the snapshot events (and possibly the normal state-change events) include incarnation numbers for their underlying nodes. An incarnation number is incremented every time a node is restarted (or possibly every time the node changes state). This allows the system to determine if the node has changed by comparing the incarnation number with a previous incarnation number for the same node. (Note that incarnation numbers can also be associated with distributed components.)

Finally, the system forwards the snapshot events to subscribers that are registered to be notified of the events (step 610). Note that the normal event notification mechanism will automatically forward the snapshot events to registered subscribers.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for recovering from a failure in a distributed event notification system within a distributed computing system, comprising:
detecting a failure of an event forwarder, which notifies subscribers of events generated by distributed components in the distributed computing system, wherein the event forwarder is part of the distributed event notification system;
restarting the event forwarder;
requesting a snapshot of current state from the distributed components;
in response to the request, receiving events from the distributed components that specify current state of the distributed components; and
forwarding the events to subscribers that are registered to be notified of the events.

2. The method of claim 1, wherein the events that specify the current state of the distributed components are received at the event forwarder through normal event notification channels.

3. The method of claim 1, wherein cluster membership events received from the distributed components include incarnation numbers for the underlying nodes of the distributed components, wherein the incarnation numbers allow subscribers to determine if a given underlying node has changed since the last time an event was received from the given underlying node.

4. The method of claim 1, wherein events generated by the distributed components are associated with changes of state in the distributed components.

5. The method of claim 4, wherein events generated by the distributed components provide snapshots of current state information for the distributed components, instead of merely providing incremental state changes.

6. The method of claim 1, wherein the distributed components can include:
nodes in the distributed computing system;
applications running on nodes in the distributed computing system; and
application components running on nodes in the distributed computing system.

7. The method of claim 1, wherein an event can include:
a node joining a cluster in the distributed computing system;
a node leaving the cluster in the distributed computing system;
a state change related to an application or an application component running within the distributed computing system;
a state change for a group of related applications running within the distributed computing system; and
a state change related to application monitoring.

8. The method of claim 1, wherein the subscribers can include:
applications or application components running within the distributed computing system; and
applications or application components running outside of the distributed computing system.

9. A computer-readable storage medium storing instructions that when executed by a computer cause the computer to perform a method for recovering from a failure in a distributed event notification system within a distributed computing system, the method comprising:
detecting a failure of an event forwarder, which notifies subscribers of events generated by distributed components in the distributed computing system, wherein the event forwarder is part of the distributed event notification system;
restarting the event forwarder;
requesting a snapshot of current state from the distributed components;
in response to the request, receiving events from the distributed components that specify current state of the distributed components; and
forwarding the events to subscribers that are registered to be notified of the events.

10. The computer-readable storage medium of claim 9, wherein the events that specify the current state of the distributed components are received at the event forwarder through normal event notification channels.

11. The computer-readable storage medium of claim 9, wherein cluster membership events received from the distributed components include incarnation numbers for the underlying nodes of the distributed components, wherein the incarnation numbers allow subscribers to determine if a given underlying node has changed since the last time an event was received from the given underlying node.

12. The computer-readable storage medium of claim 9, wherein events generated by the distributed components are associated with changes of state in the distributed components.

13. The computer-readable storage medium of claim 12, wherein events generated by the distributed components provide snapshots of current state information for the distributed components, instead of merely providing incremental state changes.

14. The computer-readable storage medium of claim 9, wherein the distributed components can include:
nodes in the distributed computing system;
applications running on nodes in the distributed computing system; and
application components running on nodes in the distributed computing system.

15. The computer-readable storage medium of claim 9, wherein an event can include:
a node joining a cluster in the distributed computing system;
a node leaving the cluster in the distributed computing system;
a state change related to an application or an application component running within the distributed computing system;
a state change for a group of related applications running within the distributed computing system; and
a state change related to application monitoring.

16. The computer-readable storage medium of claim 9, wherein the subscribers can include:
applications or application components running within the distributed computing system; and
applications or application components running outside of the distributed computing system.

17. An apparatus that facilitates recovering from a failure in a distributed event notification system within a distributed computing system, comprising:
a detection mechanism configured to detect a failure of an event forwarder, which notifies subscribers of events generated by distributed components in the distributed computing system, wherein the event forwarder is part of the distributed event notification system;
a restarting mechanism configured to restart the event forwarder;
a requesting mechanism configured to request a snapshot of current state from the distributed components;
a receiving mechanism configured to receive events from the distributed components that specify current state of the distributed components; and
a forwarding mechanism configured to forward the events to subscribers that are registered to be notified of the events.

18. The apparatus of claim 7, wherein the events that specify the current state of the distributed components are received at the event forwarder through normal event notification channels.

19. The apparatus of claim 17, wherein cluster membership events received from the distributed components include incarnation numbers for the underlying nodes of the distributed components, wherein the incarnation numbers allow subscribers to determine if a given underlying node has changed since the last time an event was received from the given underlying node.

20. The apparatus of claim 17, wherein events generated by the distributed components are associated with changes of state in the distributed components.

21. The apparatus of claim 20, wherein events generated by the distributed components provide snapshots of current state information for the distributed components, instead of merely providing incremental state changes.

22. The apparatus of claim 17, wherein the distributed components can include:
nodes in the distributed computing system;
applications running on nodes in the distributed computing system; and
application components running on nodes in the distributed computing system.

23. The apparatus of claim 17, wherein an event can include:
a node joining a cluster in the distributed computing system;
a node leaving the cluster in the distributed computing system;
a state change related to an application or an application component running within the distributed computing system;
a state change for a group of related applications running within the distributed computing system; and
a state change related to application monitoring.

24. The apparatus of claim 17, wherein the subscribers can include:
applications or application components running within the distributed computing system; and
applications or application components running outside of the distributed computing system.
